(19) United States
(12) Patent Application Publication
(10) Pub. No.: US 2004/0208543 A1
(43) Pub. Date: Oct. 21, 2004

(54) Multiplexer and pulse generating laser device

(75) Inventor: Kurt Weingarten, Zurich (CH)

Correspondence Address: RANKIN, HILL, PORTER & CLARK LLP, 4080 ERIE STREET, WILLOUGHBY, OH, 44094-7836, US

(73) Assignee: GigaTera AG, Dietikon (CH)

(21) Appl. No.: 10/097,910

(22) Filed: Mar. 13, 2002

(51) Int. Cl. H04J 14/00; H04J 14/08

(52) U.S. Cl. 398/47

(57) ABSTRACT

A multiplexer for producing an output continuous-wave train of electromagnetic radiation pulses from an input continuous-wave train of electromagnetic radiation pulses is disclosed, the pulse repetition frequency of the output train of pulses exceeding the pulse repetition frequency of the input train of pulses. The time domain multiplexer comprises a planar lightwave integrated circuit (PLC) at least two integrated beam couplers and at least two intermediate integrated waveguide paths arranged between said beam couplers, the optical lengths of said two waveguide paths being different. The optical beam path difference is chosen and said time beam couplers are designed in a manner that said device is for multiplexing trains of electromagnetic pulses with an input pulse repetition frequency exceeding 1 GHz into at least one train of electromagnetic pulses with an output pulse repetition frequency being larger by a factor N≧2. The invention also comprises a method of producing an output continuous-wave train of electromagnetic radiation pulses from an input continuous-wave train of electromagnetic radiation pulses and a pulse generating device with a laser unit and a multiplexer unit.

### FIELD OF THE INVENTION

The invention is in the field of generating short or ultra-short pulses of laser radiation with a high pulse repetition frequency, i.e. in with a repetition frequency exceeding 1 GHz, preferably exceeding 9 GHz. It especially relates to a multiplexer for producing at least one output continuous-wave train of laser pulses from an input continuous-wave train of laser pulses, the pulse repetition frequency of the output train of laser pulses exceeding the pulse repetition frequency of the input train of laser pulses. It also relates to a laser device comprising a pulse generating laser coupled to a multiplexer for producing at least one output continuous-wave train of laser pulses from an input continuous-wave train of laser pulses, the pulse repetition frequency of the output train of laser pulses exceeding the pulse repetition frequency of the pulse generating laser. It further relates to a method of multiplexing a train of laser pulses.

### BACKGROUND OF THE INVENTION

In optical communication, signals may be transmitted by series of radiation pulses in an optical fiber system. Due to the ever growing importance of the field of optical communication, the generation of a series of short or ultrashort electromagnetic radiation pulses with as high a repetition frequency as possible has thus become an important target of research and developement activities.

Recently, a pulse generating laser comprising a solid state gain element and operating at a pulse frequency as high as 10 GHz has been developed. Such a laser is disclosed in U.S. patent application Ser. No. 09/962,261, which is incorporated herein by reference. The pulse generating laser of this patent application uses the mode locking technique for generating short pulses and operates with pulsewidths in the 2 to 20 ps range. It achieves an average output power of exceeding 20 mW with the potential for more.

However, although it is possible to continue to increase the repetition rate of the pulse generating lasers, there are several trade-offs or even limitations, which are due to the basic physics of the laser. One of them is the Q-switched mode locking (QML) for lasers mode locked by means of passive absorbers with a non-linear absorption characteristics, due to which under certain conditions the pulse energy is modulated. This is usually not desired. In order to avoid QML operation, the radiation intensity on the SESAM has to be increased. This could lead to a decrease in the lifetime and reliability of this component. Also, as the pulse repetition frequency goes up, the requirements on the pump laser (higher brightness) and the gain medium (which should be able to handle a high pump power intensity) become more demanding.

Next to these trade-offs related to the QML threshold, there are also other limitations due to which the manufacturing of pulse generating lasers with an even more enhanced pulse repetition frequency becomes increasingly difficult. For example, for a (fundamental) repetition rate of 40 GHz, there is a total free-space cavity length of 3.75 mm, which is reduced even further due to the index of refraction of the glass laser element of about 1.5, so that a typical physical length of the laser cavity might be smaller than 3 mm. This also leaves very little space for inserting tuning and pulsewidth control elements with for example wavelength control and filter mechanisms. One possible trade-off with these restrictions might be the achievable average output power from pulse generating laser for a given pump power available.

It would therefore be desirable to have a means for multiplying the pulse repetition frequency of a series of pulses emitted by a pulse generating laser. According to the invention, this is achieved by time-domain multiplexing.

Optical time-domain multiplexing as such is well known in the state of the art. A simple, conventional approach to increase the repetition rate of the a pulse train would be to split a beam using a beam splitter and then to recombine these two beams with another beam splitter, but with an appropriate delay, so that the two beams combine to create an interleaved pulse train in the time domain. The beam may be split and recombined using beam splitters, for example consisting of a glass substrate with an appropriate dielectric coating, the glass substrate being placed in a manner that it comprises an angle of 45° to the beam direction(s). This approach is also analogous to a Mach-Zehnder interferometer, except that with pulses in the time domain, there is not the typical interference fringes generated, as long as there is no overlap of pulses in the time-domain.

This “bulk-optic” approach would result in two approximately equal amplitude beams emerging from the second beam splitter, each with the same polarization and the same pulse train.

This process can be repeated again, to further increase the repetition rate by a factor of two, such that the total multiplex factor N equals 4. Given that the input pulse train of approximately 10 GHz matches the defined telecom line rates (SONET/SDH OC-192 is 9.953 GHz for example), this 4× multiplexing would result in a pulse train at exactly the required line rate for the next SONET/SDH standard (for example OC- 768 at 39.812 GHz).

Note that one issue with this approach is that each of the N resulting output beams has its average output power reduced by the total multiplexing factor N. This is in the ideal case of a conservation of the total power, neglecting possible losses or imbalances at each of the beam splitter elements.

There is a technique to improve the average power per beam and to reduce the number of output beams. A beam can be split using a polarization sensitive beam splitter, such that one output beam's polarization is flipped by 90 degrees with respect to the polarization of the other output beam's polarization. Then another polarizing beam splitter would be used to combine these two beams. This allows a 2× multiplexing to occur, without any loss of average power, i.e. the beam would consist of a train of pulses, at 2× the original input repetition rate, but each pulse would be followed by a pulse with a 90° polarization change.

There have been suggestions to adapt the above described “bulk-optic” multiplexing approaches to analogous fiber-optic components. “Bulk-optic” devices as described can be then essentially replicated by analogous fiber-optic components, such that the entire device is made within a fiber-optic assembly. In this case, the beam splitter is replaced by a fiber coupler, and the delay corresponds to a fiber of a longer length in one arm.

All these state-of-the-art multiplexers bulk-optics or fiber-based—have in common that they require a careful, hand-crafted, micron tolerance assembly of the different optical path lengths of beam paths corresponding to the necessary delays. State-of-the art multiplexers are thus large, individually-handled pieces and therefore not well-suited for applications like telecommunication where there is a large pressure on the manufacturers to produce low-price components with exact, precise specifications.

Further, adaptations to ever growing pulse repetition frequencies bringing about ever decreasing relative delays between the multiplexed pulses requires a constant miniaturization. However, such bulk-optics or fiber-based multiplexers may not be scaled down below a certain size since the manufacturing techniques and also the adjustment of the components require the parts to have a certain size. Therefore, time-domain multiplexing for pulse frequencies in the GHz becomes increasingly difficult.

Zamkotsian et al. (F. Zamkotsian et al., IEEE photonics technology letters 7, No. 5, 502, 1995, F. Zamkotsian et al., Journal of Ligthwave technology 14, No, 10, 2344, 1996) have disclosed lightwave circuits built on InP for producing 100 GHz pulse-trains using multimode interference splitters and taper-type combiners. Such devices seemingly manage to produce output pulse trains with 100 GHz repetition rates from input pulse of a lower repetition rate. However, this technology is not suitable for mass production and for communication technology, since InP based structure are expensive and lossy. Also, a large wafer size is required, which fact renders mass production not feasible.

### SUMMARY OF THE INVENTION

It is thus an object of the present invention to provide a multiplexer which overcomes the above mentioned disadvantages and which is suited for multiplexing a pulse train with a pulse repetition frequency exceeding 1 GHz, preferably exceeding 9 GHz. It is a further object of the invention to provide a multiplexer which is compact and may be fabricated in large series at low cost. A still further object of the invention is to provide a multiplexer which is suited for multiplexing radiation emitted by pulse generating lasers emitting electromagnetic radiation characterized by a vacuum wavelength of around 1.55 μm or by a vacuum wavelength of around 1.3 μm. Another object of the invention is to provide a pulse generating device comprising a pulse generating laser and a multiplexer, the pulse generating laser for emitting a continuous wave train of radiation pulses with a pulse repetition frequency exceeding 1 GHz, preferably exceeding 9 GHz.

According to the invention, a multiplexer for producing an output continuous-wave train of electromagnetic radiation pulses from an input continuous-wave train of electromagnetic radiation pulses, the pulse repetition frequency of the output train of pulses exceeding the pulse repetition frequency of the input train of pulses is provided.

This time domain multiplexer comprises a planar lightwave integrated circuit (PLC) with

at least one input location and at least one output location

at least two integrated beam couplers arranged dowstream of said input location,

at least two intermediate integrated waveguide paths arranged between said beam couplers, the optical lengths of said two waveguide paths being different,

said optical beam path difference being chosen and said time beam couplers being designed in a manner that said device is for multiplexing trains of electromagnetic pulses with an input pulse repetition frequency exceeding 1 GHz into at least one train of electromagnetic pulses with an output pulse repetition frequency being larger by a factor N≧2.

It is understood that in the context of this application, “lightwave” stands for electromagnetic radiation waves of any frequency, i.e. IR radiation, visible light, possibly also microwave radiation, ultraviolet radiation, . . . Special emphasis, in the context of this application is laid upon radiation in the near infrared and in the visible range.

The multiplexer according to the invention may be compact and can be manufactured at low cost. It supports sophisticated set-ups which allow to minimize losses.

The planar lightwave integrated circuit may further comprises at least one integrated on-chip modulator, such that the output continuous-wave train of electromagnetic radiation pulses may be modulated. This means that the planar lightwave integrated circuit is such that the output directly consist of a data stream. By this means, it is possible, for example using a 10 GHz pulse repetition rate laser, to directly produce a 40 GHz data stream with one integrated device.

A pulse generating device according to the invention comprises a pulse generating laser unit with

an optical resonator,

a laser gain element placed in said optical resonator,

means for exciting said laser gain element to emit electromagnetic radiation,

said pulse generating laser being designed for emitting trains of electromagnetic pulses with a pulse repetition frequency exceeding 1 GHz,

said device further comprising a time domain multiplexer unit, an input location of said time domain multiplexer unit being optically coupled to an output of said pulse generating laser, said time domain multiplexer unit comprising any embodmiment of the multiplexer according to the invention.

This invention also concerns a method of multiplexing pulsed radiation beams and a method of producing at least one pulsed data carrying output beam from a plurality of pulsed data carrying input beams, the output beam having a higher data transmission rate than the input beam.

In the following discussion, most aspects of the invention are explained with reference to 2× multiplexing of a electromagnetic radiation beam consisting of a pulse train with a pulse repetition frequency exceeding 1 GHz. It is understood, that this does not mean that these aspect of the inventions are restricted to 2× multiplexing. They equally well apply to 4× multiplexing, 8× multiplexing, and, using different coupler strenghts, also to multiplexing by other, non-binary factors.

This invention is based on the discovery that a small, robust, low-cost multiplexer can be provided with PLC technology which is designed for time domain multiplexing radiation pulses with a repetition frequency of 1 GHz, 9 GHz or more. A further discovery is the fact that the pulse quality in such a device may be largely conserved, a good output pulse quality is thus possible. Still further, a small, robust pulse generating laser can be combined with such a multiplexer, such that the pulse repetition frequency of the pulse generating laser can economically be increased by a factor of 2×, 4×, 8× or by any other factor, such that a laser designed for one SONET/SDH line rate can be converted to a laser for the next higher line rate.

The pulse repetition frequency, the pulse length and the multiplexing factor are such that the multiplexed output pulses essentially do not overlap. Further, the input radiation of the multiplexer should have a good contrast ratio, i.e. a high ratio between the pulse intensity and the radiation intensity between the pulses, since the multiplexed radiation beam will overlap between the pulses. A pulse generating laser unit of a pulse generating device according to the invention should thus feature a good contrast rate. In the case where the contrast ratio was poor, this could either cause some amplitude modulation of the pulses due to interference between the pulse and the underlying background and/or a decrease in the optical signal to noise ratio/eye diagram quality, also due to the underlying background around each pulse. contrast ratios of more than 10 dB, preferably more than 15 dB, especially preferred of more than 20 dB should be achieved.

### BRIEF DESCRIPTION OF THE DRAWINGS

In the following, embodiments of the invention are described with reference to drawings. In the drawings,

FIG. 1 schematically shows a multiplexing set-up according to the state of the art,

FIG. 2 shows a multiplexing scheme according to the state of the art,

FIG. 3 shows a schematic cross section through a SiON/SiO₂ planar lightwave integrated circuit structure for a multiplexer according to the invention, the structure not being shown true to scale,

FIG. 4 shows a schematic lightwave path and integrated beam coupler arrangement of a planar lightwave circuit strucure

FIG. 5 shows a scheme of an integrated circuit structure of a 4× multiplexer,

FIG. 6 represents a scheme of a further integrated circuit structure of a 4× multiplexer,

FIG. 7 shows yet a further scheme of an integrated circuit structure of a 4× multiplexer,

FIG. 8 represents a scheme of a 4× multiplexer comprising a polarization modifying element,

FIG. 9 represents a scheme of a multiplexer for combining four data channels into one data channel comprising pulses having a higher bit per second rate,

FIG. 10 shows a scheme of a pulse generating device according to the invention, and

FIG. 11 represents a scheme of a laser unit of a pulse generating device according to the invention.

### DESCRIPTION OF THE PREFERRED EMBODIMENTS

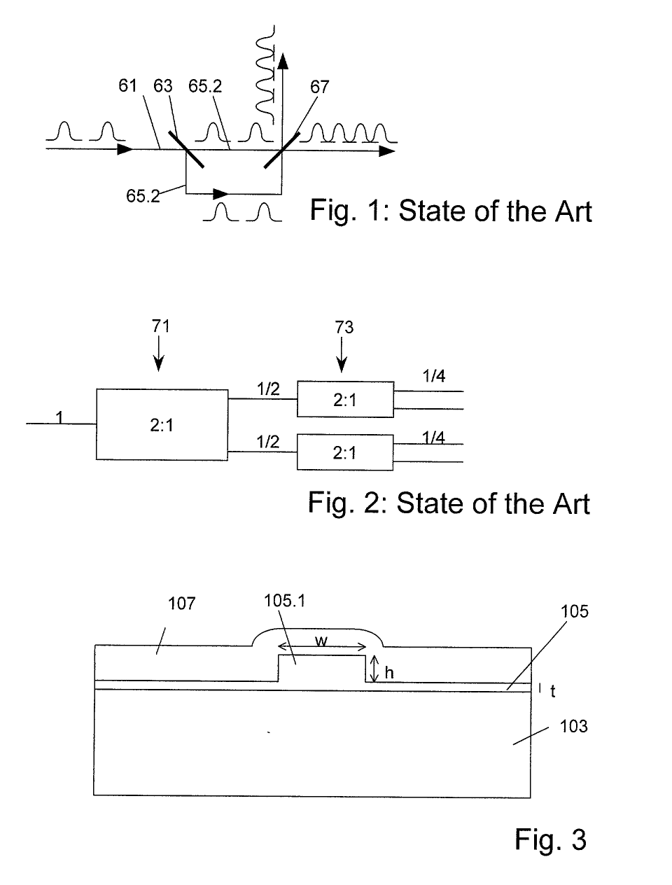

The multiplexer according to the state of the art shown in FIG. 1 is suitable for time-domain multiplexing of light pulses with pulse repetition frequencies of a couple of hundred of MHz in laboratory applications but becomes more difficult to apply for GHz pulses. It comprises a first beam splitter 63 for splitting an input beam 61 into a first and a second intermediate beam 65.1, 65.2 of approximately half the average intensity of the input beam. Such a beam splitter may consist of a glass substrate with an appropriate dielectric coating, the glass substrate being placed in a manner that it comprises an angle of 45° to the beam direction(s). By means of mirror or waveguide elements (not shown), these two beams are guided to a second beam splitter 67. The beam path difference i.e. the delay between the first and the second intermediate beam paths, for example corresponds to half the pulse-to-pulse time period. The intermediate beams are incident on the same spot on the second beam splitter, such that the deflected beam proportion of the first intermediate beam coincides with the non-deflected beam proportion of the second intermediate beam and vice versa. The entire device has two output beams with each half the intensity of the input beam, if losses and asymmetries are neglected. This is not counting losses or imbalances at each beam splitter. This beam splitting multiplexing procedure may be the first stage 71 of a 4× multiplexer, which procedure may be repeated by two 2× multiplexers in a second stage 73. The delay of the second stage multiplexers corresponds to a quarter of the pulse-to-pulse time period of the initial beam, resulting in four output beams with at most a quarter of the initial average intensity but with a four times higher pulse repetition frequency, as symbolized in FIG. 2.

This set-up, next to the disadvantages described above, which render it unsuitable for multiplexing GHz repetition frequency pulses, also features the drawback that it results in a plurality of output beams each with a reduced average intensity. Further, sophisticated recombination has to be applied at every second beamsplitter stage, since a perfect spatial overlap of the beam contributions from different intermediate beam paths are required.

In contrast, according to the invention, the multiplexer comprises a planar lightwave integrated circuit (PLC) structure.

Planar waveguide structures as such have are known already. For a detailed account on manufacturing processes as well as on properties of such structures and of coupling and adjustment means (such as selective heaters), the reader is referred to the publication of R. Germann et al, Journal of The Electromechanical Society, 147, 2237-2241 (2000), the teaching of which publication is incorporated herein by reference. The teaching of this description includes structures comprising the coupling and adjustment means of this reference.

In the following description, the principles of planar lightwave structures are not explained in detail any more. Rather, the description concentrates on the principles of multiplexers according to the invention.

In FIG. 3, a schematic cross section through a waveguide of an embodiment of the planar waveguide integrated circuit is shown. The substrate 103 is a SiO₂ glass plate having an index of refraction of n_{S}=1.45. On this glass plate, a structured SiON 105 layer (index of refraction: n=1.50) with a ridge like protrusion 105.1 is arranged. The tickness t of the layer in the example described here is below 1 μm, for example t=0.65 μm. the protrusions have a height h of about double the thickness of the layer and a width w between 1.5 μm and 8 μm, for example between 2.5 μm and 4 μm. This structure allows to guide electromagnetic radiation of 1.55 μm vacuum wavelength in a way that it is centered in the protrusion 105.1. In a ‘Geometrical Optics’ picture, the guiding of the electromagnetic radiation rays is caused by reflections of the light at the interface between the high index material and the low index material once the light is coupled into the waveguide. The structured layer of the second material may further be covered by a covering layer 107, for example of the first material. At least the second material is transparent for electromagnetic radiation of the kind to be multiplexed, for example of a frequency f=c/λ μm (λ being the free space wavelength, for example λ=1.55 μm or λ=1.3 μm) in the present example, where c denotes the vacuum speed of light.

As described in more detail in the above mentioned reference, SiON waveguides may be fabricated using plasma enhanced chemical vapor deposition (PECVD) or other known fabrication techniques. Due to the relatively high index contrast, the minimum bending radius of waveguides may be as low as 0.8 mm with minimal losses. This allows for complex beam path arrangements on the circuit, which make a compact circuit of a size of 1 cm² or less possible. Using this property, lightwave paths may be arranged in sophisticated patterns in a planar lightwave integrated circuit structure. This property makes SiON waveguides a preferred technology for the invention. Its short pontential bending radii make them especially suitable for picosecond laser pulses or picosecond delays (3 mm correspond to 10 ps for free space radiation).

Of course also other waveguide materials may be used, such as P-doped silica, Ge-doped silica, Ti-doped silica etc. Further waveguides on integrated lightwave circuits may be fabricated using ion implantation in glassy materials or crystals etc.

Waveguides may also be made up of transparent material with metallic reflecting walls. Methods of fabricating such waveguides in integrated circuit like structures have recently been developed, for example using fabricating process steps known from the fabrication of integrated circuits with electrically conducting structures. As yet other alternatives, the planar lightwave integrated circuit structure may comprise other forms of integrated waveguides according to the state of the art or according to new developments.

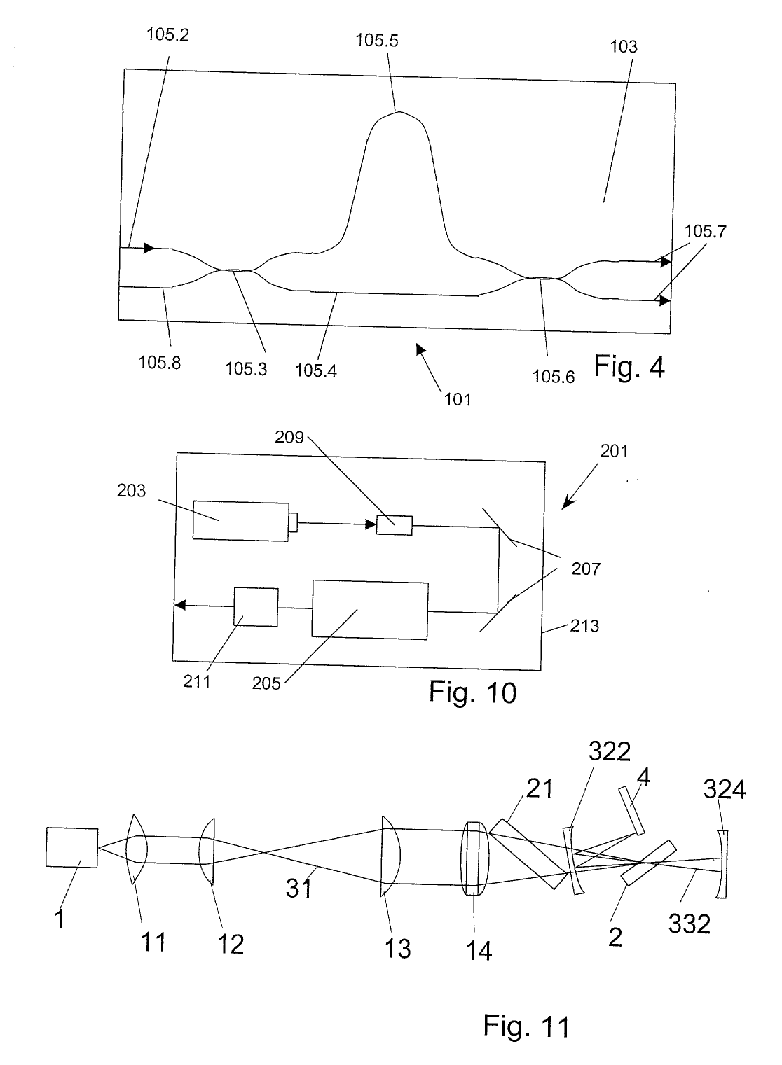

A schematic representation of the beam paths of a planar lightwave integrated sturcture of a basic multiplexer is shown in FIG. 4. The planar lightwave integrated circuit structure 101 shown in the figure comprises a substrate 103 of a first material, and a waveguide structure 105 formed on the substrate. The waveguide structure 105 may be formed by a structured layer of a second material with an index of refraction greater than the index of refraction of the substrate layer, the waveguides of the waveguide structure forming ridge like protrusions as shown in FIG. 3.

The waveguide paths formed by the waveguide structure 105 comprise an input location 105.2, a first beam coupler 105.3, a first and a second intermediate proportion 105.4, 105.5, a second beam coupler 105.6, and two output locations 105.7. In the terminology of this application, the waveguide proportion leading to the beam couplers are called “input branches” of the respective beam coupler, whereas the waveguide proportions directly downstream of the beam couplers are called “output branches” of said beam couplers. The first and the second intermediate proportions constitute beam path lengths such that there is a delay, so that pulsed input beams combine in the second beam coupler 105.6 to create an interleaved pulse train in the time domain. The path length difference is for example such that it corresponds to half the input pulse-to-pulse time period, i.e. Δ/2=c*tₚₚ/(2*n), where Δ/2 is the path length difference, c is the vacuum speed of light, n is the index of refraction of the waveguide material, and tₚₚ is the input pulse-to-pulse time period. For example, tₚₚ, in the case of a 10 GHz pulse repetition rate input beam, amounts to 100 ps. The double path length difference Δ is then 30 mm divided by the index of refraction of the waveguide material. The first beam coupler, the first and second intermediate proportions and the second beam coupler together form a (first) pulse repetition frequency doubling stage.

A second branch 105.8 upstream of to the first beam coupler 105.3 is not connected to any input location.

The expert will understand that in order to increase the compactness of the circuit structure 101, the waveguides may be arranged on the substrate in different geometries using the space of the waveguide more efficiently than shown in the figure.

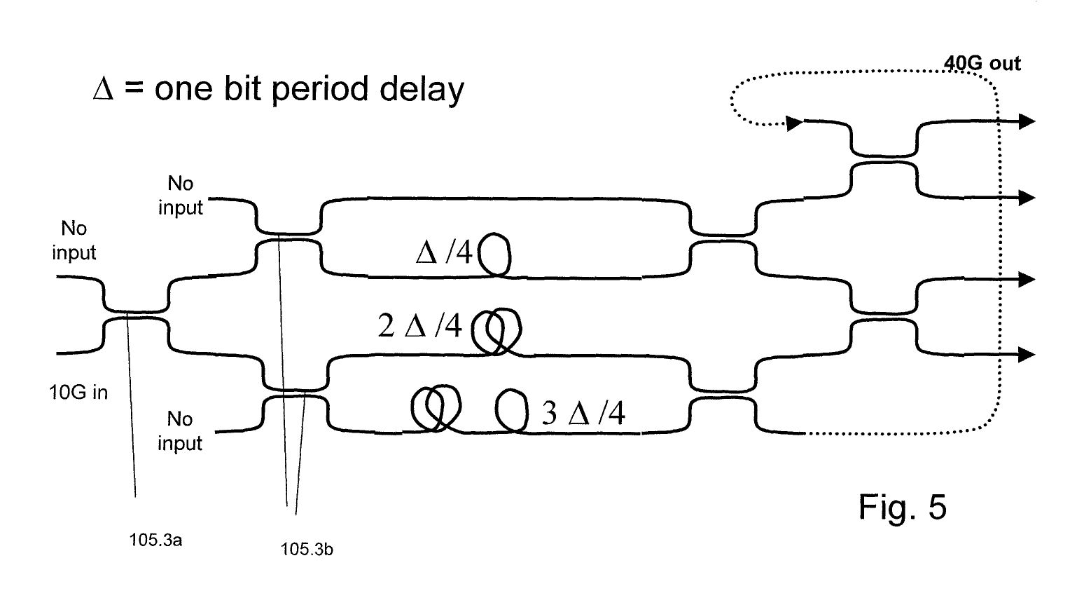

In FIGS. 5 through 9, beam path schemes are represented very schematically, which are, according to the invention, implemented by one single planar lightwave integrated structure or a plurality of planar lightwave integrated structures. Like elements in the figures are, in order to keep this text concise, not referenced in every figures. Further, in order to be concrete, the examples concentrate on a multiplexer for a 10 GHz (10 G) repetition frequency input laser. It goes without saying, that the expert will know how to modify the multiplexer adjusting beam path lengths etc. to work for other repetition frequencies.

The set-up of FIG. 5 comprises two stages of consecutive first beam couplers 105.3a, 105.3 b which split the input beam into four proportions. The respective proportions, in the subsequent intermediate waveguide proportions, are delayed by 0, Δ/4, Δ/2, and 3Δ/4 with respect to each other, respectively. The device results in four output beams, each with a four times higher pulse repetition frequency but with a power reduced by a factor four (neglecting losses). “No Input” in this Figure as well as in the following Figures denotes a waveguide branch which does not have in input location (but could be modified to have one).

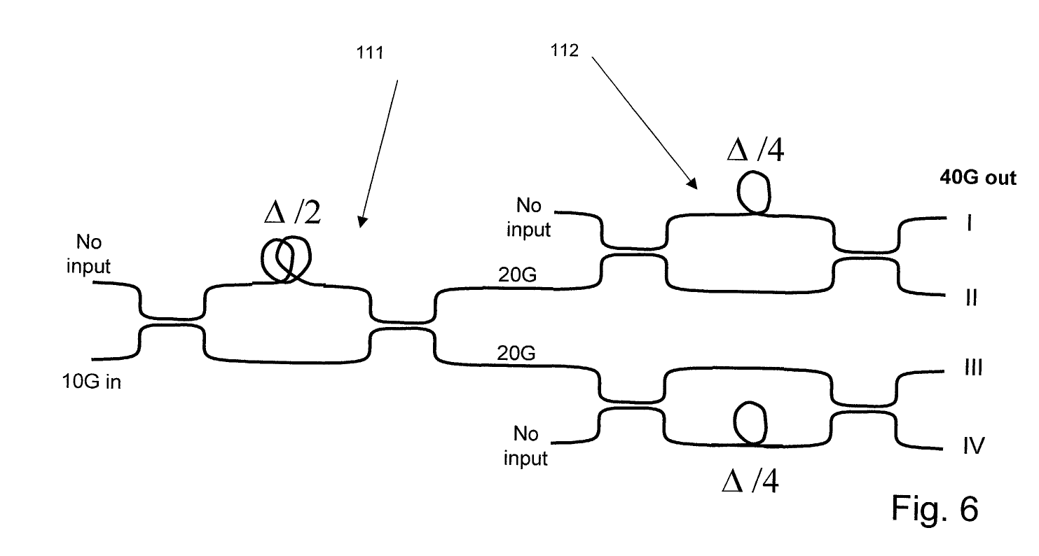

FIG. 6 shows a set-up which also results in four output beams, each with a four times higher pulse repetition frequency but with a power reduced by a factor four from one input beam. The set-up contains a first multiplexing stage 111 and a second multiplexing stage 112, the second multiplexing stage for multiplexing both first stage output beams resulting from the first stage each in a separate branch. In the first stage, the time delay corresponds to Δ/2, in each branch of the second stage to Δ/4 or vice versa.

An interesting aspect of the multiplexer of FIG. 6 is encountered when the relative phase shifts of the pulses resulting in the respective output locations I, II, III, and IV are considered. Radiation which, in a beam coupler, is coupled from one waveguide proportion into an other, is phase shifted by 90, whereas the phase remains unchanged for radiation remaining in one waveguide proportion at the waveguide coupler. In the following, a change of waveguide is denoted by “C”, whereas a passage of a beam coupler without a waveguide change is “B”. In the example of FIG. 6, the following sequence of pulses is obtained in each output location:

| Output | | Relative |
|---|---|---|
| location | Sequence | Phase shifts (in °) |
| I | BCBC, BCCB, CBBC, CBCB | 180, 180, 180, 180 |
| II | BCBB, BCCC, CBBB, CBCC | 90, 270, 90, 270 |
| III | BBBB, BBCC, CCBB, CCCC | 0, 180, 180, 390 |
| IV | BBBC, BBCB, CCBC, CCCB | 90, 90, 270, 270 |

An especially interesting case is the pulse sequence of output location II, where each pulse is phase shifted by 180° with respect to the previous pulse. This corresponds to the carrier suppressed format, which is of special interest in signal transmission. Note, that this format is achieved without any extra measures.

Please note that the above considerations pertaining to the relative phase shift are based on the assumption that each arm has a perfectly adjusted length, such that the optical beam path difference corresponds very exactly to the desired value. In practice, usually heater elements for selectively heating beam path proportions are required for obtaining such exact beam path difference values. Such heater elements are described in the above cited reference by R. Germann et al. and in the references cited therein.

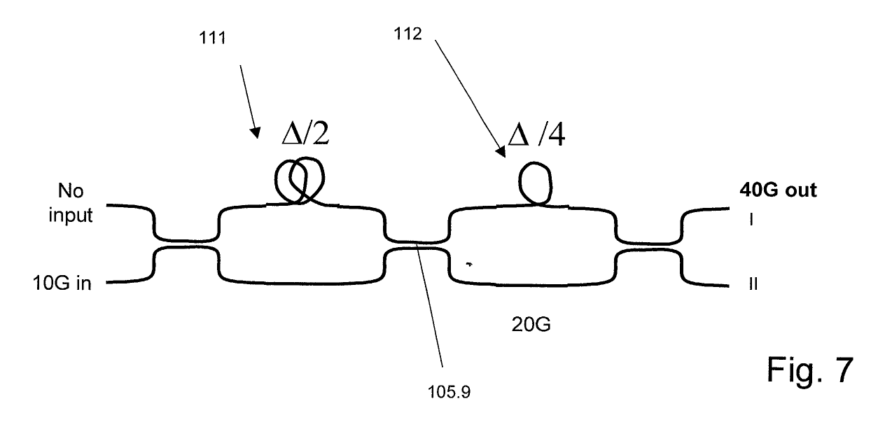

In contrast to the multiplexer of FIG. 6, the multiplexer of FIG. 7 has a second multiplexing stage comprising one multiplexing branch only. This is achieved by combining the second beam coupler of the first stage with the first beam coupler of the second stage to be one single intermediate beam coupler 105.9. Therefore, the multiplexer has only two output locations I and II, each for a beam of half the input beam intensity.

Note that a scheme of this kind could not readily be realized using bulk optics, since the alignment of recombined beams would be too delicate.

The pulse sequences in the two output locations I and II are as follows:

| Output | | Relative |
|---|---|---|
| location | Sequence | Phase shifts (in °) |
| I | BBC, BCB, CCC, CBB | 90, 90, 270, 90 |
| II | BBB, BCC, CCB, CBC | 0, 180, 180, 180 |

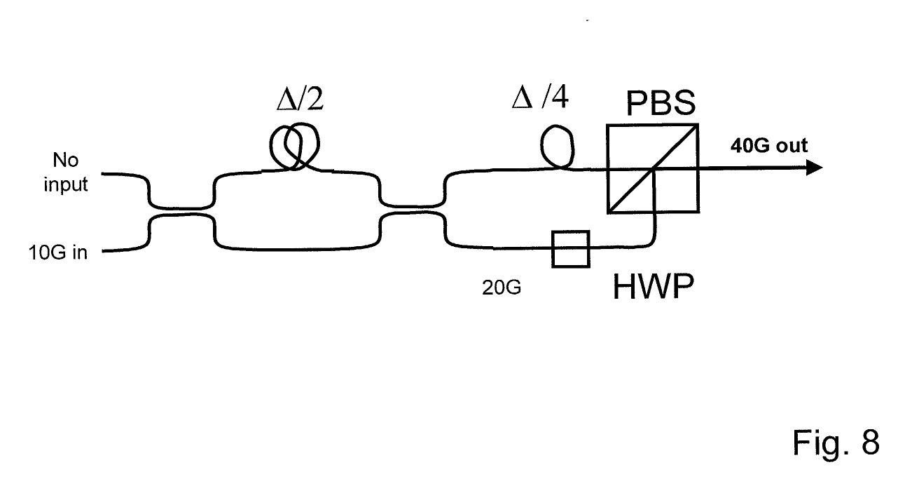

The multiplexer of FIG. 8 differs from the multiplexer of FIG. 7 in that the last of the three beam couplers is left away. Instead, one of the two outputs of the intermediate beam coupler 105.9 is led to a phase retardation element (half wave plate, denoted by HWP in the figure). Downstream of the appropriate relative delay, the two paths from said output are recombined into one single beam using a polarizing beam splitter (PBS). If the input beam of this mutliplexer is polarized, all the output radiation can be concentrated in one output location I.

Note that all components of this embodiment could be integrated in the planar lightwave sturcture. As an alternative, the half wave plate and/or the polarizing beam splitter may be external elements.

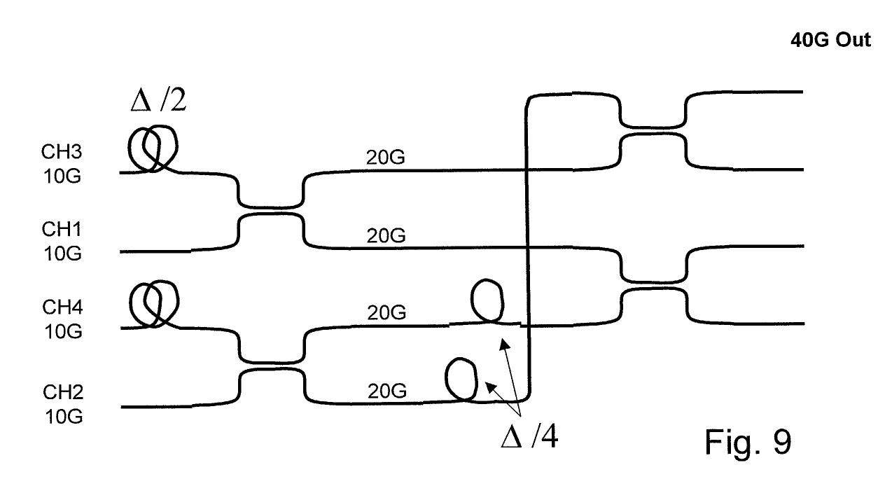

The embodiment of FIG. 9, finally, combines four already modulated beams, i.e. data carrying pulse trains, into four outputs, each channel with ¼ power, and different phase relationships but all the same data stream. Of four input beams, two pairs are built. In each pair, one beam is delayed by a Δ/2 delay. By this, the pulses of each pair are staggered with respect to each other. In first beam couplers, the beams of each pair are coupled. The output beams of one of the first beam couplers are then delayed by Δ/4 with respect to the output beams of the second beam couplers, and then one output beam of one first beam coupler are coupled with the output beams of the other first beam coupler second beam couplers.

This embodiment features the advantage that 4 data channels could be fed directly into a data channel with a higher pulse repetition frequency which is higher by a factor N (in the embodiment shown, N=4, adaptations to other factors N can readily be made).

This embodiment, apart from making a cost reduction possible, brings about the solution to an important field of problems. The communication technology expert is familiar with the fact, that modulating pulse streams with high pulse repetition frequencies is the more complicated the higher the pulse repetition frequency. The embodiment of the invention allows to modulate for example 10 GHz pulse streams, which are moderately easy to manage, and then to produce from the data stream a high bit per second rate (e.g. at 40 GHz) stream.

The generalization of the concept presented above with respect to the different embodiments to a 8×, 16×, . . . multiplexer is straightforward: One simply has to add further stages with a delay of one eight, one sixteenth, . . . of the initial input pulse-to-pulse time period in the same manner. It is as an alternative possible to add a third, fourth, . . . stage by connecting, in series, a second multiplexer to the output of a first multiplexer in a manner shown in any one of the previous figures.

The planar lightwave integrated circuit structure may further comprise integrated, possibly adjustable phase shifters, such that radiation directed trough one waveguide path may be individually phase shifted with respect to another waveguide path, enabling an actively controlled carrier-suppressed RZ format also in the cases where it does not naturally occur.

The planar lightwave integrated circuit may further comprises at least one integrated on-chip modulator, such that the output continuous-wave train of electromagnetic radiation pulses may be modulated. This means that the planar lightwave integrated circuit is such that the output directly consists of a data stream. By this means, it is possible, for example using a 10 GHz pulse repetition rate laser, to directly produce a 40 GHz data stream with one integrated device. Note that in this set-up, modulators could be integrated in the device, for example at the input locations.

FIG. 10 very schematically shows a device for producing a continuous train of laser pulses. The pulse generating device 201 comprises a pulse generating laser unit 203 and a time domain multiplexer unit 205 of the kind described above. An input location of this time domain multiplexer unit—for example comprising in-coupling means—is arranged downstream of the pulse generating laser unit and is optically coupled to the pulse generating laser unit output, i.e. the radiation emitted by the laser unit is directed to the input of the multiplexer. This may for example be done using light directing means such as optical fibers or deflecting elements 207. The device may further comprise optical components 209, 211 for influencing the radiation beam. These components may comprise passive and/or active components such as lenses, interferometers, polarizers, wavelength selective elements, Faraday isolators, dispersion-compensating devices, pre-chirp generating devices, amplifiers, . . . They may, depending on the particular task, be arranged between the laser unit and the multiplexer unit or downstream of the multiplexer unit.

The device may further comprise a casing 213 in which all device components are arranged.

Although in the schematic FIG. 10, for reasons of simplicity, the laser unit and the multiplexing unit are both shown as individual, spatially separated units, this is not a requirement. If the pulse generating laser unit is an optically pumped laser, the elements of the pump optics, of the laser cavity, and the multiplexing unit may be arranged within the casing in any appropriate manner. For example, the laser pump optics may use up most of the space within the casing 213, whereas the laser cavity and the multiplexer unit are for example comparably small elements arranged wherever appropriate. Further, the laser unit and the multiplexing unit may be integrated to form one monolithic device comprising a laser cavity and a multiplexer and possibly further comprising pumping means. To this end, it is even possible to Er and Yb dope the waveguide for lasing means or to dope the waveguide by other ions which can be used for lasing activity.

Next, an example of a pulse generating laser unit 203 which features the desired high contrast ratio is described in somewhat more detail.

Referring now to FIG. 11, a high-brightness, single-mode diode laser 1 (Nortel Model G06d), which emits 980 nm laser light 31 of up to 0.5 W from an aperture size of approximately 1.8 μm by 4.8 μm, is collimated by a short focal length high numerical aperture aspheric pickup lens 11 (focal length 4.5 mm). The beam is then expanded in tangential direction with help of a ×2 (times-two) telescope made of cylindrical lenses 12, 13. This telescope turns the elliptic pump beam into an approximately round one and it allows for astigmatism compensation. An achromatic lens 14 is used to focus the pump beam 31 through one cavity mirror 22 down to a radii between 20 and 80 μm in the free space. Between the focusing lens 14 and the cavity mirror 22, a dichroic beam splitter 21 is placed (highly reflective for wavelengths around 1550 nm and highly transmissive around 980 nm under 45° incidence) in order to deflect any laser light directed to the pump laser 1.

Although single-mode pump diodes are preferable, other formats pump diodes may also be used with properly designed pump optics. For example a 1 W output power from a 1×50 micron aperture broad area diode laser (slightly reduced brightness, but still a so called high-brightness pump laser) emitting at substantially 980 nm (Boston Laser Model 1000-980-50) can also be used to achieve good lasing performance. The advantage of the higher brightness, and in particular the single-spatial-mode diode laser, which has very high brightness, is that for a given pump mode radius the divergence of the pump beam is smaller. This allows for mode matching of the pump beam to the laser mode over the entire length of the gain element even for very small laser and pump spot sizes and thus results in a maximized saturation parameter Sₗₐₛₑᵣ of the laser (Sₗₐₛₑᵣ=Fₗₐₛₑᵣ/F_{sat,laser}). The number of elements of the pump optics can reduced by using special astigmatic lenses. Likewise a fiber coupled pump element with a comparable brightness can be used.

This pump source (using varying focal length of the achromatic lens 14) is used for four different laser set-ups which all have in common that they have a small laser mode size in the gain medium as well as on the SESAM. These small mode areas are crucial to suppress the laser from operating in the QML regime. The gain element in all these four cavities is a 1 mm thick Kigre QX/Er phosphate glass doped with 0.8% Erbium and 20% Ytterbium (i.e., the glass melt was doped with 0.8% Er₂O₃ and with 20% Yb₂O₃). The thickness of the gain medium is chosen to be not significantly more than the absorption length, to minimize the re-absorption losses. The described laser cavities contain a Brewster/Brewster-cut gain element. Analogous cavities can be done with flat/Brewster or flat/flat gain elements, compensating for the change in astigmatism.

The cavity shown in the figure is a so-called “dog leg” cavity. This laser resonator is formed by three mirrors. One is a SESAM device 4 of the kind discussed above. The other ones are concave curved mirrors 322, 324. The first curved mirror 322 has high reflectivity around 1550 nm and high transmission around 980 nm. The second curved mirror 324 is a concave curved output coupler with a transmission of 0.2-2% at the laser wavelength (around 1550 nm). The Er:Yb:glass gain element 2 is inserted under Brewster angle close to the beam waste of the laser beam 332 between mirror the first and the second curved mirror 322, 324. The gain element has dimensions of 9×9 mm² in cross-section with a nominal length of 1 mm (note that the gain element can also be a flat/Brewster element or a flat/flat shaped element with an additional polarization selective element in the cavity). The cavity length is set according to the required laser repetition rate (for example about 15 mm for 10 GHz operation). The curvature of the first curved mirror 322 can be much smaller than the cavity length (for example radius of curvature 4.1 mm). The curvature of the second curved mirror 324 is chosen so as to get the desired mode size in the gain medium and the desired cavity length. A reasonable value for 10 GHz operation is a radius of curvature of 5 mm. This cavity allows for very small mode sizes of the laser light in the gain medium and on the SESAM, which in addition can be custom designed independently. The mode size of the pump light 31 in the gain element has to be about equal to the mode size of the laser light 332 at this position. This sets the focal length of the focusing lens 14. Again, the dichroic mirror 21 is then use to avoid any feedback of laser light leaking through the high reflector 322 into the pump laser or the pulse generating laser itself. This cavity allows for individual adjustment of the mode sizes in the gain medium and in the SESAM, still having small mode sizes in the gain. In addition to these advantages, this cavity design shows a small effect of spatial hole burning, as the gain element is located far away from the cavity end mirrors compared to the thickness of the gain element. This is beneficial to get transform-limited pulses.

In one specific embodiment, we choose the first curved mirror 322, i.e. the high reflecting mirror, to have a radius of curvature of 4.1 mm, and the second curved mirror 324 to have a radius of curvature of 5 mm with a reflectivity of 99.5% at the laser wavelength. The distance between the Er:Yb:glass 2 and the first curved mirror 322 is approximately 5.2 mm, the distance between the Er:Yb:glass 2 and the curved output coupler is approximately 4.8 mm, and the distance from the first curved mirror 322 to the SESAM 4 is approximately 3.2 mm. This gives a nominal total cavity length of approximately 15.0 mm (taken into account the effective length of the laser gain element 2, i.e., its index of refraction of n=1.521 times its physical length along the optical path of 1.2 mm), which corresponds to a nominal free spectral range (i.e., laser repetition rate) of 10 GHz. In this configuration, the mode radius in the gain medium is 24 μm in the tangential plane and 18 μm in the sagittal plane. On the SESAM, they are 10 μm and 10 μm, respectively.

Of course, the expert in the field will know many other solid state or other (semiconductor etc.) gain media and many other cavity designs for constructing an appropriate laser unit. An other preferred example of a gain medium, next to the gain media described in the mentioned US patent application, is Nd:vanadate, Nd:YAG, Nd:YLF, Yb:YAG, Yb:KWG, Nd:glass and many others.

Numerous other embodiments may be envisaged, without departing from the spirit and scope of the invention. Especially, all embodiments of the multiplexer according to the invention may be combined with any pulse generating laser.

What is claimed is:

1. A multiplexer for producing an output continuous-wave train of electromagnetic radiation pulses from an input continuous-wave train of electromagnetic radiation pulses, the pulse repetition frequency of the output train of pulses exceeding the pulse repetition frequency of the input train of pulses,
the time domain multiplexer comprising a planar lightwave integrated circuit (PLC) with
at least one input location and at least one output location
at least two integrated beam couplers arranged dowstream of said input location,
at least two intermediate integrated waveguide paths arranged between said beam couplers, the optical lengths of said two waveguide paths being different,
said optical beam path difference being chosen and said time beam couplers being designed in a manner that said device is for multiplexing trains of electromagnetic pulses with an input pulse repetition frequency exceeding 1 GHz into at least one train of electromagnetic pulses with an output pulse repetition frequency being larger by a factor N≧2.

2. The multiplexer of claim 1 being designed for multiplexing trains of electromagnetic pulses with an input pulse repetition frequency exceeding 4 GHz.

3. The multiplexer of claim 2 being designed for multiplexing trains of electromagnetic pulses with an input pulse repetition frequency of substantially 9 GHz or more.

4. The multiplexer of claim 1 wherein a multiplexing factor of the pulse repetition rate of N=4, 8, 16, . . . is achieved by providing a plurality of beam couplers arranged in series.

5. The multiplexer of claim 1 being designed for multiplexing laser pulses of an effective frequency corresponding to essentially f=c/1.55 μm, where c is the vacuum speed of light.

6. The multiplexer of claim 1 being designed for multiplexing laser pulses of an effective frequency corresponding to essentially f=c/1.3 μm, where c is the vacuum speed of light.

7. The multiplexer of claim 1 wherein said at least one beam coupler, said at least two waveguide paths and said at least one beam coupler are being defined by refractive index contrast structures of said planar lightwave integrated circuit.

8. The multiplexer of claim 1 comprising a glass substrate with an N-doped silica layer structured in a manner that waveguides are formed.

9. The multiplexer of claim 8 wherein the waveguides are formed by ridge like protrusions of the N-doped silica.

10. The multiplexer of claim 9 wherein the N-doped silica layer is further covered by a Silicon oxide (SiOₓ, 0<x≦2) layer.

11. The multiplexer of claim 1, comprising two multiplexing stages arranged in series, wherein the optical beam path difference of one stage corresponds to half the input pulse-to-pulse spacing and wherein the optical beam path difference of the other stage corresponds to a quarter of the input pulse-to-pulse spacing, such that output trains of pulses are created, the pulse repetition frequency of which corresponds to four times the input pulse repetition frequency.

12. The multiplexer of claim 1 comprising at least a first, a second and a third beam coupler, two first intermediate beam paths being arranged downstream of said first beam coupler and upstream of said second beam coupler, two second intermediate beam paths being arranged dowstream of said second beam coupler and upstream of said third beam coupler, the optical beam path lengths of said first intermediate beam paths being different by a first beam path delay, the optical beam path lengths of said second intermediate beam paths being different by a second beam path delay, said first and said second beam path delays being different.

13. The multiplexer of claim 1 comprising a polarization rotation means and a polarizing beam coupler arranged downstream of said polarization rotation means.

14. The multiplexer of claim 13, wherein said polarization rotation means and said polarizing beam coupler are integrated into said planar lightwave integrated circuit.

15. The multiplexer of claim 1 comprising a plurality of input locations.

16. The multiplexer of claim 15 being designed in a manner that a plurality of pulsed input beams being modulated in a manner that they carry information with a first data transmission rate per time unit combine to at least one output beam carrying information from said plurality of input beams and having a second data transmission rate exceeding said first data transmission rate.

17. The multiplexer of claim 1, wherein said planar lightwave integrated circuit further comprises at least one integrated on-chip modulator, such that the output continuous-wave train of electromagnetic radiation pulses may be modulated.

18. The multiplexer of claim 1, being designed in a manner that it is suited for multiplexing trains of electromagnetic pulses with a contrast ratio of substantially exceeding 10 dB.

19. The multiplexer of claim 18, being designed in a manner that it is suited for multiplexing trains of electromagnetic pulses with a contrast ratio of substantially exceeding 20 dB.

20. A pulse generating device, comprising a pulse generating laser unit with
an optical resonator,
a laser gain element placed in said optical resonator,
means for exciting said laser gain element to emit electromagnetic radiation,
said pulse generating laser being designed for emitting trains of electromagnetic pulses with a pulse repetition frequency exceeding 1 GHz,
said device further comprising a time domain multiplexer unit for producing an output continuous-wave train of electromagnetic radiation pulses from an input continuous-wave train of electromagnetic radiation pulses, an input location of said time domain multiplexer unit being optically coupled to an output of said pulse generating laser,
said time domain multiplexer comprising a planar lightwave integrated circuit (PLC) with
at least one input location and at least one output location
at least two integrated beam couplers arranged dowstream of said input location,
at least two intermediate integrated waveguide paths arranged between said beam couplers, the optical lengths of said two waveguide paths being different,
said optical beam path difference being chosen and said time beam couplers being designed in a manner that said device is for multiplexing trains of electromagnetic pulses with an input pulse repetition frequency exceeding 1 GHz into at least one train of electromagnetic pulses with an output pulse repetition frequency being larger by a factor N≧2.

21. The device of claim 20, wherein said laser gain element is a Er:Yb:glass laser, and wherein said means for passive mode locking comprise a semiconductor saturable absorber device.

22. The device of claim 20, wherein said laser gain element features a contrast rate of essentially exceeding 10 dB.

23. The device of claim 22, wherein said laser gain element features a contrast rate of essentially exceeding 20 dB.

24. A method of producing an output continuous-wave train of electromagnetic radiation pulses from an input continuous-wave train of electromagnetic radiation pulses with a pulse repetition frequency exceeding 1 GHz, the pulse repetition frequency of the output train of pulses exceeding the pulse repetition frequency of the input train of pulses, comprising the steps of
feeding the input continuous-wave train of electromagnetic radiation pulses to a time domain multiplexer comprising a planar lightwave integrated circuit (PLC)
splitting said input continuous-wave train of electromagnetic radiation pulses by means of least one beam coupler integrated in said PLC,
directing radiation proportions resulting from said beam splitting via at least two integrated waveguide paths, the optical lengths of said two waveguide paths being different,
and re-combining said radiation using a beam coupler integrated in said PCL.

25. A method of producing at least one pulsed data carrying output beam having a second data transmission per time unit rate from a plurality of pulsed data carrying input beams having a first data transmission per time unit rate, said first rate being smaller than said second rate,
said method comprising the steps
delaying at least one of said plurality of input beams in a manner that pulses of different of said plurality of input beams are staggered with respect to each other
coupling at least two of said input beams with staggered pulses by means of least one beam coupler integrated in a planar lightwave integrated circuit (PLC),
obtaining said at least one output beam from at least one output branch of said at least one beam coupler.

26. A method as claimed in claim 25, comprising coupling two pairs of input beams with mutually staggered pulses by means of two first beam couplers in a PLC and then coupling in at least one second beam coupler in said PCL at least one output branch of each of said two first beam couplers for obtaining said output branch from at least one output branch of said at least one second beam coupler, wherein pulsed data carrying beams of input branches of said second beam coupler are staggered.
